(19) United States
(12) Patent Application Publication
(10) Pub. No.: US 2012/0029918 A1
(43) Pub. Date: Feb. 2, 2012

(54) SYSTEMS AND METHODS FOR RECORDING, SEARCHING, AND SHARING SPOKEN CONTENT IN MEDIA FILES

(76) Inventor: Walter Bachtiger, Novato, CA (US)

(21) Appl. No.: 13/271,195

(22) Filed: Oct. 11, 2011

Related U.S. Application Data
(63) Continuation-in-part of application No. 12/861,787, filed on Aug. 23, 2010, now abandoned.
(60) Provisional application No. 61/244,096, filed on Sep. 21, 2009.
(60) Provisional application No. 61/392,411, filed on Oct. 12, 2010.
(60) Provisional application No. 61/415,575, filed on Nov. 19, 2010.

(51) Int. Cl. G10L 15/26

(52) U.S. Cl. 704/235; 704/E15.043

(57) ABSTRACT

Systems for recording, searching for, and sharing media files among a plurality of users are disclosed. The systems include a server that is configured to receive, index, and store a plurality of media files, which are received by the server from a plurality of sources, within at least one database in communication with the server. In addition, the server is configured to make one or more of the media files accessible to one or more persons—other than the original sources of such media files. Still further, the server is configured to transcribe the media files into text; receive and publish comments associated with the media files within a graphical user interface of a website; and allow users to query and playback excerpted portions of such media files.

### CROSS-REFERENCE TO RELATED APPLICATIONS

This application is a continuation-in-part of U.S. patent application Ser. No. 12/861,787, filed on Aug. 23, 2010, which claims priority to U.S. provisional patent application Ser. No. 61/244,096, filed on Sep. 21, 2009. This application further claims priority to U.S. provisional patent application Ser. No. 61/392,411, filed on Oct. 12, 2010, and U.S. provisional patent application Ser. No. 61/415,575, filed on Nov. 19, 2010.

### FIELD OF THE INVENTION

The field of the present invention relates to systems and methods for recording, indexing, transcribing, storing, searching, and sharing various types of media files and the audio tracks included within such media files.

### BACKGROUND OF THE INVENTION

Systems for recording and storing media files have been available for many years and, indeed, are used by many individuals and businesses today. In addition, currently-available systems allow users to retrieve, either using a telephone or internet connection, media files that may be stored in a database and correlated with a specific user of the system. Although these systems have become a ubiquitous part of communication (and communication management) in today's world, these systems do not efficiently capture, utilize, and make available to others, the value of the content stored within such media files.

For example, currently-available systems do not efficiently allow users to search for and share recorded media files with other persons and, more importantly, publish comments regarding the content of a particular media file for a plurality of other users to view. More particularly, such currently-available systems do not efficiently allow users to search for, share, and publish comments regarding specific and limited portions of the content of a particular media file, for a plurality of other users to review. In addition, currently-available systems do not efficiently allow users to query a large body of different media files for content (i.e., audio tracks of the media files) that relates to a particular topic—or rank such media files in order of relevance to a particular topic. Still further, such communication management systems fail to adequately incentivize users to share, publish, and make available to others the media files that may be recorded within a particular database used by such systems.

In addition, for those currently-available systems that do employ an audio-to-text transcription function, such conversions of audible words into text are too often not accurate. For example, some methods will simply convert and transcribe an audible word into the “best fit” text, without notifying the reader that the conversion may not be accurate (or otherwise carries a lower probability for being an accurate transcription). Other methods and systems may convert and transcribe an audible word into text and, if such conversion does not exhibit a preferred accuracy confidence, the text will be displayed in manner that is different from the surrounding text, e.g., transcribed words that carry a lower accuracy confidence may be shown in grey font or otherwise visually set apart from other text (which does exhibit a preferred accuracy confidence level). These currently-available methods and systems will often portray the transcribed text in a manner that is difficult to read, and has a tendency to present transcribed text in a manner that fails to instill a sense of accuracy and robustness to the viewer.

As described further below, the present invention addresses many of these, and other, drawbacks that are associated with currently-available media storage and retrieval systems.

### SUMMARY OF THE INVENTION

According to certain aspects of the present invention, systems are provided for recording, searching for, and sharing media files among a plurality of users. More particularly, the systems generally comprise a server that is configured to receive, index, and store a plurality of media files, which are received by the server from a plurality of sources, within at least one database in communication with the server. In addition, the invention provides that the server is configured to make one or more of the media files accessible to one or more persons—other than the original sources of such media files. In other words, if certain conditions are satisfied, the media files that a first person records within the database of the system will be accessible by other persons. Still further, according to such embodiments of the invention, the server is preferably configured to receive and publish comments associated with specific portions of the media files within a graphical user interface of a website. The invention provides that the comments may be submitted to the server through the website by persons other than the original sources (or authors) of such media files. As explained further below, the media files that are stored within the server may be derived from audio-only content (e.g., a telephone conversation or talk radio content) or, in certain cases, may comprise audio tracks derived from a video file (which has an audio component embedded therein).

According to further aspects of the present invention, systems and methods for converting audio tracks into text (using one or more algorithms) if, and only if, such conversion satisfies a minimum accuracy confidence threshold are provided. Such text files—converted from audio tracks (audio content)—may then be stored, indexed, displayed within a graphical user interface, and shared with others using the systems described herein. Furthermore, according to certain embodiments, the invention provides that other non-literary symbols are used to signify the presence of those audio-to-text conversions that do not meet the predefined minimum accuracy confidence threshold. That is, according to such embodiments, the server may be instructed to display a non-literary symbol for each word that was converted into text from the audio tracks, but which does not meet or exceed the predefined accuracy confidence threshold. The invention further provides that a non-literary symbol may be shown for each letter that comprises the word that does not meet or exceed the predefined accuracy confidence threshold. For example, if the non-displayed word includes five letters, the transcription results would display five consecutive non-literary symbols (to indicate the number of letters that are included in the non-displayed word).

According to yet further aspects of the present invention, systems for searching and accessing excerpted portions of media files, e.g., talk radio files and voice recordings, are provided. The systems generally comprise a server that is configured to receive, index, and store a plurality of media files, as described above, which are received by the server from a plurality of sources, within at least one database in communication with the server. The server is, preferably, further configured to provide a means within a graphical user interface of a website to search a plurality of the media files for the presence of one or more key words. Still further, the server is configured to provide a means for automatically streaming audio tracks to a device (after performing the search), whereby the audio tracks represent an excerpted portion of a media file that begins at a predefined period of time prior to a location of the queried key word in the audio track.

According to related aspects of the present invention, upon selecting a media file within the search results, the server will publish (in a graphical user interface) a limited portion of text that has been transcribed from the corresponding audio track (e.g., voice recording). The invention provides that a word (or group of words) may be selected from within this body of text, whereupon the server will stream audio content to a device which represents an excerpted portion of the corresponding audio track (e.g., voice recording) that begins at (or, alternatively, at a predefined period of time prior to) a location of the selected word (or group of words).

According to additional aspects of the present invention, systems for recording and sharing media files are provided, which incentivize users of the system to share, publish, and make available to others the media files that may be recorded within a particular database. According to such embodiments, the systems generally comprise a server that is configured to (a) receive, index, and store a plurality of media files, which are received by the server from a plurality of sources, within at least one database in communication with the server; and (b) make one or more of the media files accessible to persons other than the original sources (or authors) of such media files, as described herein.

According to such embodiments, the server is also configured to track the number of media files shared by each user of the system. The invention provides that a media file is considered “shared” when a user makes a media file accessible to, or otherwise refers the media file to, another user of the system. Still further, the invention provides that the server may, optionally, be configured to grant credit to each user of the system based on the number of media files shared by each user during a defined period of time. According to such embodiments, the credit that is granted to each user may be redeemed, for example, in exchange for the right to use the system without charge (for a defined period of time) or other forms of consideration.

According to further aspects of the present invention, methods for recording, indexing, storing, transcribing, and sharing media files are provided, which generally comprise the use of the systems described herein.

The above-mentioned and additional features of the present invention are further illustrated in the Detailed Description contained herein.

### BRIEF DESCRIPTION OF THE FIGURES

FIG. 1 is a diagram showing the different components of the systems described herein.

FIG. 2 is a diagram showing the interactive nature and media file sharing capability of the systems described herein.

FIG. 3 is a flow chart illustrating the controls provided by the systems described herein, which allow only specified users to access certain media files and/or comments related thereto within the centralized website.

FIG. 4 is a diagram showing certain non-limiting components of an exemplary graphical user interface in which a user may query the content of a plurality of media files, identify those media files which include a certain key word (or set of key words) that the user defines, and quickly view the context in which such key word is used in one or more media files.

FIG. 5 is a flow diagram that summarizes certain audio-to-text transcription methods of the present invention.

FIG. 6 is a non-limiting example of certain output of an audio-to-text conversion using the methods and systems of the present invention.

FIG. 7 is a diagram that illustrates the means by which the systems and methods described herein allow users to query a large body of media files—and then playback excerpted and relevant portions thereof.

FIG. 8 is another diagram that illustrates the means by which the systems and methods described herein allow users to query a large body of media files, and then playback excerpted and relevant portions thereof using a media player.

FIG. 9 is a flow diagram that summarizes the systems and methods described herein, which allow users to search for and playback excerpted portions of certain media files that contain key words.

### DETAILED DESCRIPTION OF THE INVENTION

The following will describe, in detail, several preferred embodiments of the present invention. These embodiments are provided by way of explanation only, and thus, should not unduly restrict the scope of the invention. In fact, those of ordinary skill in the art will appreciate upon reading the present specification and viewing the present drawings that the invention teaches many variations and modifications, and that numerous variations of the invention may be employed, used and made without departing from the scope and spirit of the invention.

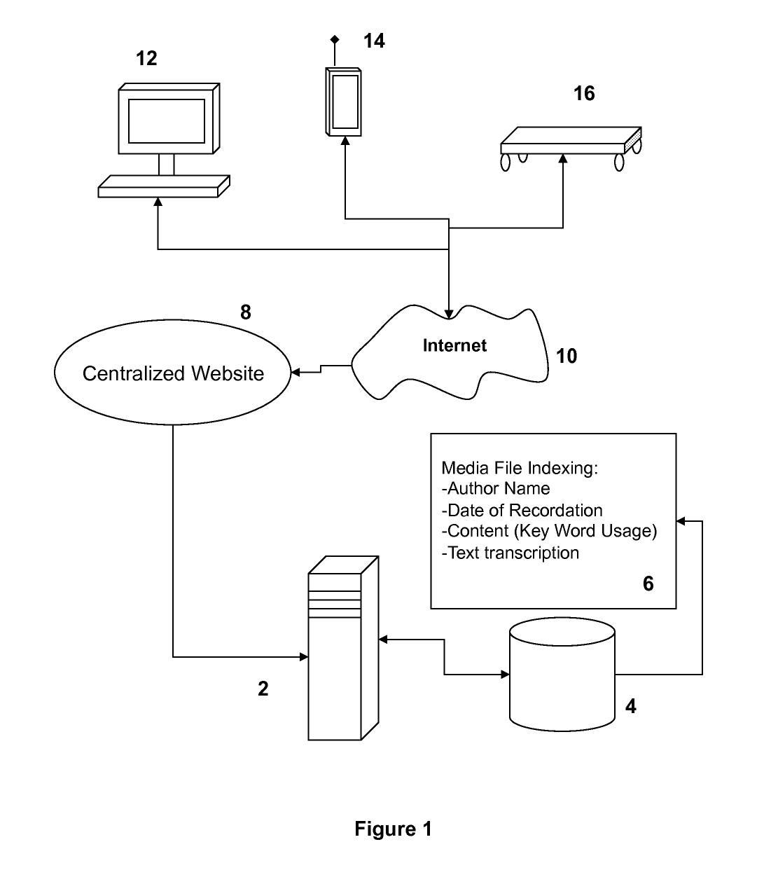

According to certain preferred embodiments, the present invention generally encompasses systems for recording, indexing, transcribing, and sharing media files among a plurality of users. As used herein, the term “media file(s)” refers to audio files, video files, voice recordings, streamed media content, and combinations of the foregoing. Referring to FIG. 1, the systems generally comprise a server 2 that is configured to receive, index, and store a plurality of media files, which are received by the server 2 from a plurality of sources, within at least one database 4 in communication with the server 2. The invention provides that the database 4 may reside within the server 2 or, alternatively, may exist outside of the server 4 while being in communication therewith via a network connection.

The media files may be indexed 6 and categorized within the database 4 based on author, time of recordation, geographical location of origin, IP addresses, language, key word usage, combinations of the foregoing, and other factors. The invention provides that the media files are preferably submitted to the server 2 through a centralized website 8 that may be accessed through a standard internet connection 10. The invention provides that the website 8 may be accessed, and the media files submitted to the server 2, using any device that is capable of establishing an internet connection 10, such as using a personal computer 12 (including tablet computers), telephone 14 (including smart phones, PDAs, and other similar devices), meeting conference speaker phones 16, and other devices. The invention provides that the media files may be created by such devices and then uploaded to the server 2 or, alternatively, the media files may be streamed in real time (through such devices) with the media files being created (and then indexed and stored) within the server 2 and database 4. In addition, as explained above, the invention provides that the media files that are stored within the server 2 and database 4 may be derived from audio-only content (e.g., a telephone conversation or talk radio) or, in certain cases, may comprise audio tracks derived from a video file (which has an audio component embedded therein).

The invention provides that the server 2 may receive and manage media files in many ways, such that the contents thereof may be deciphered and used as described herein. For example, as described further below, the invention provides that upon a media file being submitted to the server 2, the server 2 will perform a speech-to-text, speech-to-phoneme, speech-to-syllable, and/or speech-to-subword conversion, and then store an output of such conversion within the database 4. This way, the content of each media file may be intelligently queried and used in the manner described herein, such as for querying such content for key words.

The invention provides that when reference is made to “media files that contain a key word,” and similar phrases, it should be understood that such phrase encompasses a text file that contains the key word, with the text file being derived from a media file, as explained above. In other words, for example, after performing a speech-to-text conversion, and storing such text within the database 4, if a search is performed using the system of the present invention for media files that contain a particular key word, the system will actually search the converted text forms of such media files. Upon identifying any text forms of such media files that contain the queried key word, it will be inferred that the media file that corresponds with the searched text file will actually contain the key word.

The media files that are provided to the server 2 and database 4 may represent and be derived from, for example, a recorded telephone conversation, VoIP conversation, group meeting (through a speaker phone), speech or lecture (through a microphone), deposition or court room testimony (through a court reporter's microphone and/or transcript data entry), talk radio conversations, video content, and other audio sources. The invention provides that the systems described herein are preferably compatible with, and capable of receiving media files from, any devices that may be used among persons to communicate, to transmit communications, or to record communications. In general, the invention provides that such devices may record the media file, which may then be submitted to the server 2 as described herein. In other embodiments, the invention provides that the system may include a recordation means which records, in real time, a media file that is representative of (and streamed from) a conversation between two or more people using, for example, a cellular telephone or other electronic communication devices.

When the present specification refers to the server 2, the invention provides that the server 2 may comprise a single server or a group of servers. In addition, the invention provides that the system may employ the use of cloud computing, whereby the server paradigm that is utilized to support the system of the present invention is scalable and may involve the use of different servers (and a variable number of servers) at any given time, depending on the number of individuals who are utilizing the system at different time points, which are in fluid communication with the database 4 described herein.

According to certain embodiments, the invention provides that a limited number of fields within the database 4 (which are associated with a particular media file) may be pre-filled by a media recording device. For example, the invention provides that the title and description fields (within the database 4) that are associated with a media file may be pre-filled with information that is sourced from the calendar entries stored within, for example, a mobile phone of the user that is submitting the media file (through the mobile phone) to the server 2 and database 4. For purposes of illustration, when the user submits a media file to the server 2 and database 4 through a mobile phone, the system will automatically query any calendar entries stored within the phone and transmit relevant information to the appropriate fields of a database 4 entry that is created for the media file, such as the media file title, the names of the persons who contributed to the content of the media file, date and time of recordation, and/or other relevant information. According to such embodiments, the automatically-filled data fields would be editable by the user, in order to make any necessary corrections thereto. The invention provides that similar functionality may be implemented using other recording means, such as internet-mediated communication portals (which may allow the system to automatically query emails and/or calendar programs stored within a personal computer).

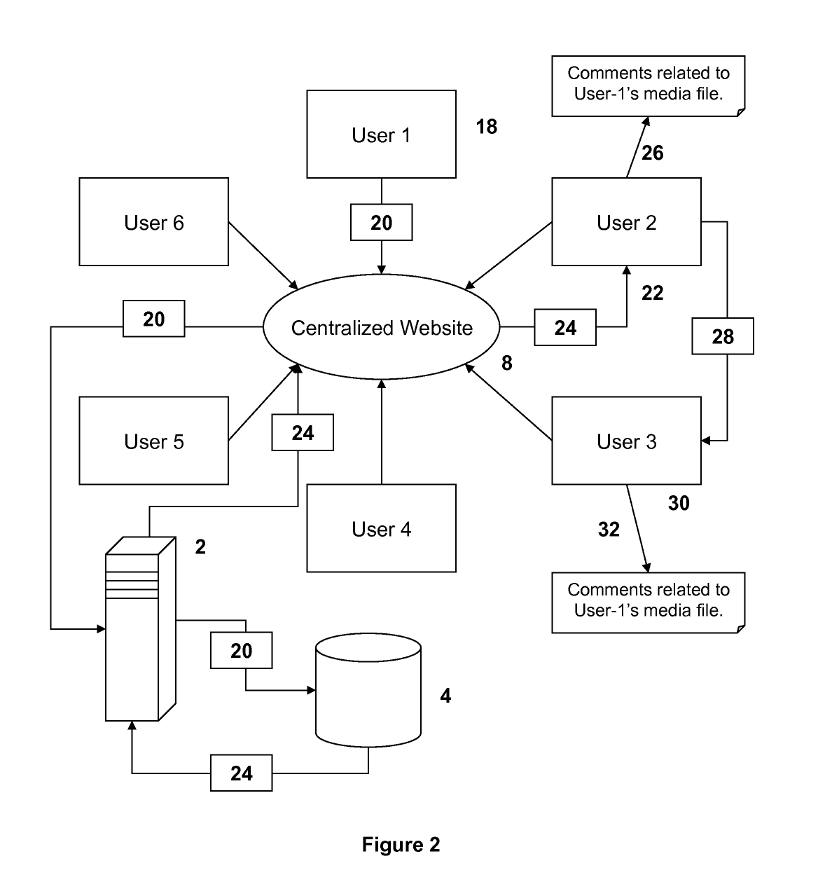

According to certain preferred embodiments, the invention provides that the server 2 is configured to make one or more of the media files accessible to persons other than the original source (or author) of the media files. The invention provides that the term “source” refers to a person who is responsible for uploading a media file to the server 2, whereas the term “author” refers to one or more persons who contributed content to an uploaded media file (who may, or may not, be the same person who uploads the media file to the server 2). For example, referring now to FIG. 2, a first user (User-1) 18 may submit 20 a media file to the server 2 through the centralized website 8, which is then indexed and stored within a database 4. The invention provides that if certain conditions are satisfied, as described below, the media files that the first user (User-1) 18 records within and uploads to the database 4 will then be accessible by other persons. For example, a second user (User-2) 22 may retrieve 24 and listen to User-1's media file from the database 4 through the centralized website 8.

Upon retrieving and accessing User-1's media file, User-2 22 may publish comments 26 regarding User-1's media files within a graphical user interface of the website 8. Moreover, User-2 22 may publish comments 26 regarding certain limited portions of User-1's media files, with the relative location of such comments being quickly ascertainable within the graphical user interface of the website 8. The invention provides that the comments 26 may be submitted to the server 2 through the website 8 by User-2 22, or any other persons who are granted access to User-1's 18 original media files. The invention provides that the comments 26 will be associated with User-1's 18 original media files within the database 4, along with other information collected by the server 2, such as the identity of the user/person submitting the comments 26, the date and time of submission, and/or other relevant information.

The invention further provides that the comments 26 may be viewed by any person accessing the website 8 or, alternatively, a limited group of persons who are granted access to User-1's 18 original media files. For example, an author of a media file, and/or the person (source) who submits a media file to the server 2, may submit instructions to the server 2 which only allow certain persons to access and listen to the media file. The invention provides that such access controls may be employed if a user (or author or source of a media file) does not want a media file to be generally available to all users of the system.

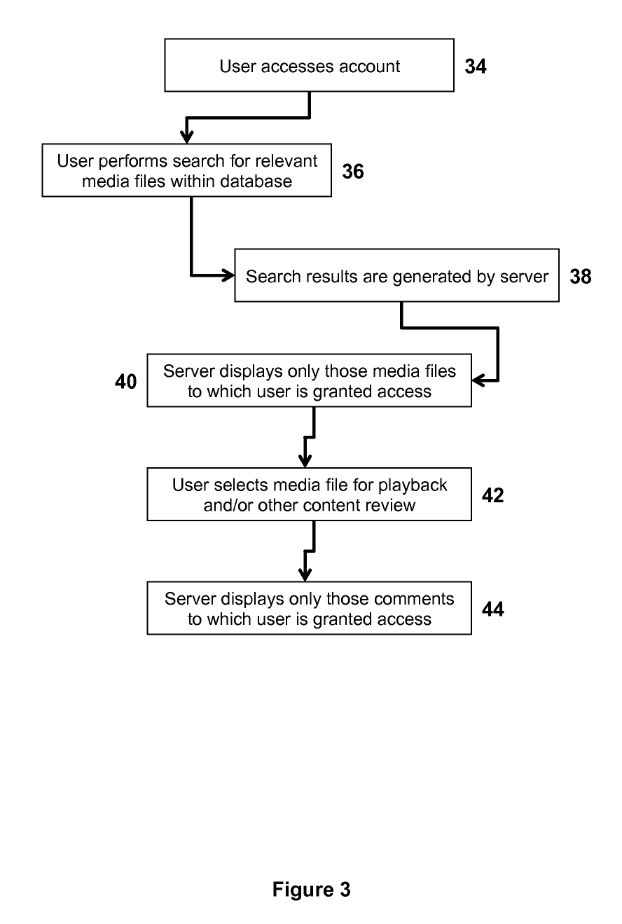

Referring to FIG. 3, for example, the invention provides that a user may access his/her account 34, by providing the server 2 with an authorized username/password through the centralized website 8. The user may then perform a search 36 of the database 4 for desired media files, namely, media files containing one or more search terms (key words), as described herein. The invention provides that the server 2 will then generate a list of results 38, i.e., media files that contain one or more of the queried search terms, and then display (within the centralized website 8) only those media files to which the user is granted access 40. The user may then select one or more media files within the viewable search results for playback and/or other content review 42. In addition, upon selecting a media file from the search results within the centralized website 8, the server 2 will display only those comments (related to the selected media file) that the user is allowed to view 44. In other words, the individuals who publish comments regarding a media file may further limit access to such comments to only authorized users of the system.

Referring now to FIG. 2, according to certain preferred embodiments, the invention provides that a user of the system, such as User-2 22, may refer 28 a media file (with or without comments 26 associated therewith) to another user. When the other user, e.g., User-3 30, receives notice of such referral 28, the other user may access and listen to the referred media file and, optionally, publish comments 32 regarding User-1's media files within a graphical user interface of the website 8. In addition, the invention provides that users of the system may share, refer, and transmit to other users a limited portion of one or more media files. For example, if a first user determines that a second user may find a particular portion of a media file to be of interest, the first user may refer only the interesting portion of that media file to the second user. According to such embodiments, the invention provides that the graphical user interface of the website 8 may include certain controls which allow a user to excise portions of a media file and refer the same to another user, e.g., by using time coordinates associated with a media file, from beginning to end, to identify and refer only the relevant portion of a media file to another user of the system. The act of referring a media file, or an excerpted version thereof, may be carried out by sending, e.g., by e-mail, a hyperlink to another individual (with the hyperlink being associated with a place in the database 4 from which the media file, or an excerpted version thereof, may be retrieved).

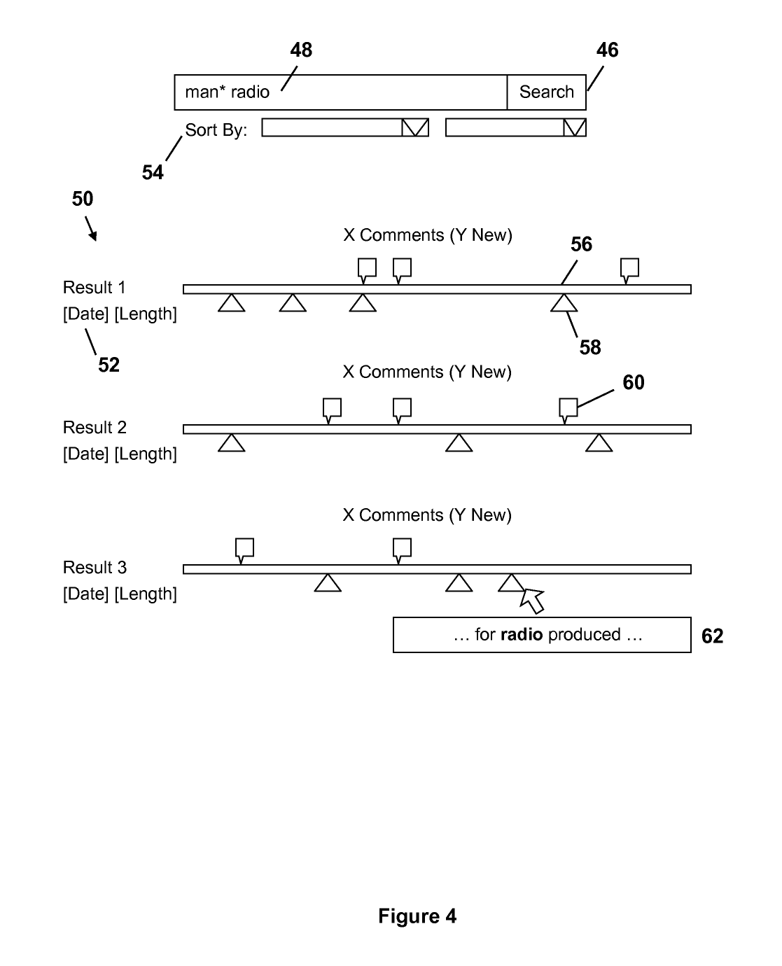

As mentioned above, according to certain preferred embodiments of the present invention, the system is configured to allow users to query the database 4, preferably through the website 8, for media files that include within the content thereof one or more key words. A non-limiting example of a portion of a graphical user interface showing an exemplary search function 46 is provided in FIG. 4. More particularly, the invention provides that the server 2 of the system may be configured to receive one or more key words 48 that are submitted by a user of the system through the website 8, whereupon the server 2 queries the database 4 to identify all media files which include the one or more key words 48. The invention provides that the system, and search function 46, may employ Boolean search logic, e.g., by allowing conjunctive and disjunctive searches, truncated and non-truncated forms of key words, exact match searches, and other forms of Boolean search logic.

The server 2 may then present the search results 50 to the user within the website 8 and, preferably, list all responsive media files in a defined order within such graphical user interface, but only those media files to which the user has been granted access, as described above. For example, the search results may list the media files in chronological order based on the date (and time) 52 that each media file was recorded and provided to the database 4. In other embodiments, the media files may be listed in an order that is based on the number of occasions that a key word is used within each media file. Still further, the media files may be listed based on the number of occurrences of key words in metadata associated with the media files, such as titles, description, comments, etc. In addition, the media files may be listed by measuring user activity, such as the number of views or plays, length of playing time, number of shares and comments, length of comments, etc. These criteria, combinations thereof, or other criteria may be employed to list the responsive media files in a manner that will be most relevant to the user. Still further, the invention provides that a user may specify the criteria that should be used to rank (and sort) the search results, with such criteria preferably being selected from a predefined list 54.

Still referring to FIG. 4, each media file included within a set of search results will preferably be graphically portrayed, such as in the form of a line 56 that begins at time equals zero (t=0) and ends at a point when the media file is terminated. For example, if the total length of a media file is five minutes, the left side of the line will be correlated with t=0 of the media file, whereas the right side of the line will be correlated with t=5 minutes of the media file. Still further, the invention provides that the location of each search term that was queried may be indicated along the line 56. For example, the location of each search term may be indicated with a triangle 58, or other suitable and readily visible element. The invention further provides that if multiple search terms were used in the search, the line 56 may be annotated with multiple triangles 58 (or other suitable elements), each of which may exhibit a different color that is correlated with a particular search term. More particularly, for example, if two search terms are used, the line 56 may be annotated with triangles 58 (or other suitable elements), which exhibit one of two colors, with one color representing a location of a first search term and a second color indicating the location of a second search term.

The invention further provides that each line 56 that represents a relevant media file may be annotated with one or more comments 60 posted by other users, as described herein. The invention provides that such annotation of the comments 60 will preferably indicate the location within the media file to which each comment 60 relates. According to yet further embodiments, the invention provides that when a user places a cursor (within the centralized website 8) over or in the near vicinity of a triangle 58 (or other element indicating the location of a search term) or a comment 60, the graphical user interface of the website 8 will automatically publish a temporary text box 62 in which the search term may be viewed, along with a limited number of words before and after the search term (i.e., the context in which the search term is used), which were transcribed by the system from the media file.

The invention provides that the text box 62 (which contains the transcribed text) will allow a user to quickly review the context in which the search term is used, which will facilitate knowing whether the media file (or a portion thereof) may be relevant to the user and worthy of playback and/or further review. According to certain embodiments, the invention provides that a user may, optionally, control the number of words appearing before and after the search term in the text box 62, by entering the desired number of words in a specified field within the user's dedicated account page. This way, each user may adjust the size of the text box 62 in accordance with his/her personal preferences.

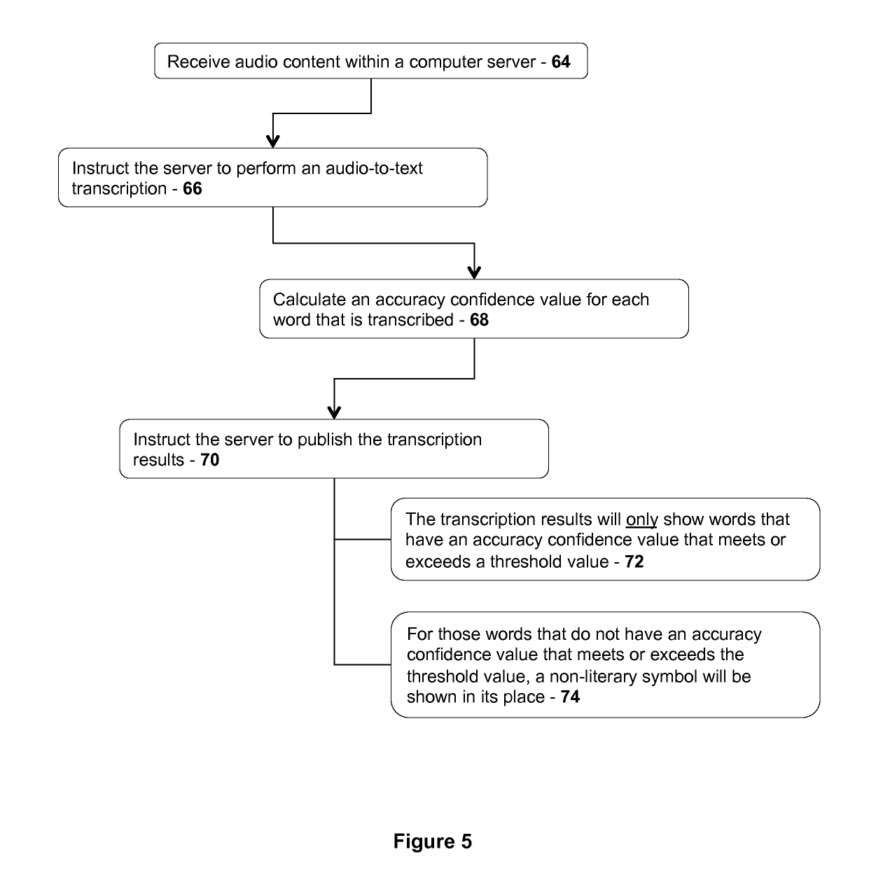

In certain embodiments, the systems and methods of the present invention will only display text that has been transcribed from a media file, which satisfies a minimum accuracy confidence threshold. The invention provides that other non-literary symbols may be used to signify the presence of certain audio-to-text conversions that do not meet the predefined minimum accuracy confidence threshold. Referring to FIG. 5, for example, the methods of the present invention include receiving a media file (audio content) 64 within the server 2, and instructing the server 2 to perform an audio content to text transcription 66 using one or more algorithms. As mentioned above, a variety of algorithms may be employed during the transcription step, including, but not limited to, algorithms that may be used to perform speech-to-text, speech-to-phoneme, speech-to-syllable, and/or speech-to-subword conversions. In certain embodiments, Hidden Markov Model algorithms may be employed to execute the transcription. The methods further comprise calculating an accuracy confidence value 68, which will be a quantitative measure of the estimated accuracy of the transcription of a word derived from the media file (audio content) into written text.

The server 2 may then (or at anytime following recordation in the database 4) be instructed to display a set of results for such transcription 70 within the centralized website 8 (whether in the text box mentioned above or in other areas of the website 8), which may be viewed from a computing device 12,14,16. The invention provides, however, that such results will include transcribed words for only those words that meet or exceed a predefined accuracy confidence threshold 72. In other words, for each word that is transcribed from the media file, the associated accuracy confidence value for such word will be compared to the predefined accuracy confidence threshold. If the accuracy confidence value meets or exceeds the predefined accuracy confidence threshold, the transcribed word will be published within the set of results for such transcription 72.

More particularly, the invention provides that such voice recognition systems contain an acoustic model as well as a language model. The acoustic model defines the conversion of waveforms to phonemes, whereas the language model governs the conversion of phonemes into words. Both models are probabilistic, insofar as a given phoneme's likelihood depends on its neighbors, and a given word's likelihood depends on its neighbors as well. The invention provides that the most general confidence measure for a word under these models is given by the following formula:
best waveform match: M_p (number between 0 and 1, measuring best overlap between a set of stored waveforms and an incoming sample waveform);
phoneme confidence: C_p=M_p which maximizes the product (M_p−x* . . . *M_p* . . . *M_p+x);
best word match: M_w=max product (C_p) where p in w (w belonging to a set of stored words and an incoming sequence of phonemes recognized above);
word confidence: C_w=M_w which maximizes the product (M_w−y* . . . *M_w* . . . *Mw+y).
   In simpler confidence models, best word matches can be defined in such a way as to not rely on the waveform matches, but more simply using a distance measure between the measured phonemes and the words in the set of stored words.

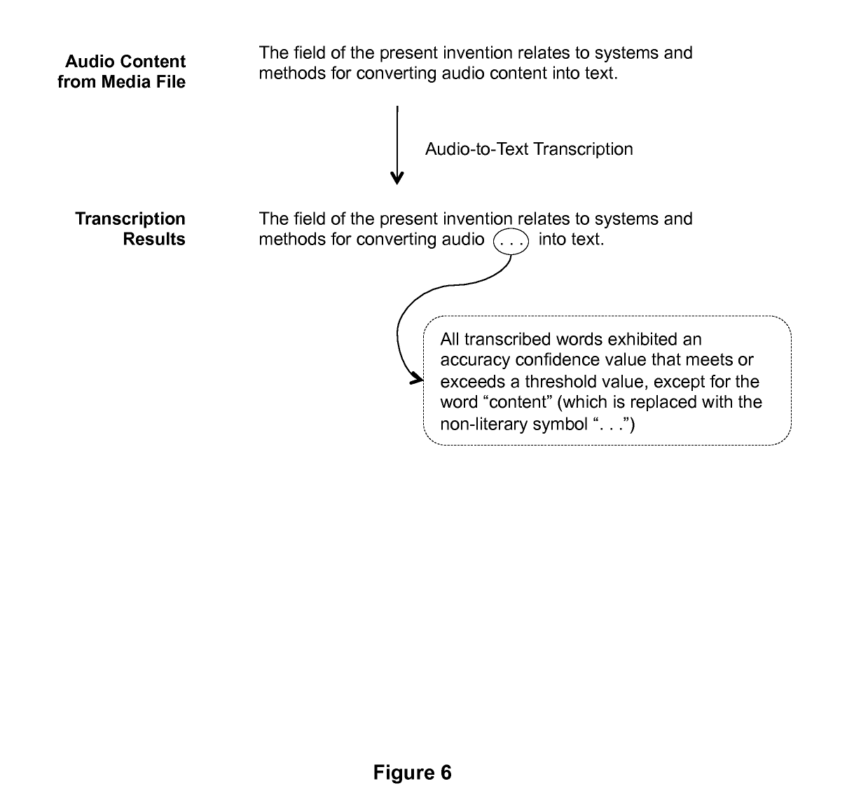

The invention provides that if the accuracy confidence value does not meet or exceed the predefined accuracy confidence threshold, the transcribed word will not be published within the set of results for such transcription and, in its place, a non-literary symbol will be shown 74. Examples of non-literary symbols include, but are not limited to, spaces (i.e., no text or symbols), punctuation marks (e.g., !, @, #, $, *, . . . , −, etc.), underscores (e.g., ______), or other symbols that are not included within the 26-letter English alphabet. A non-limiting example of such audio-to-text conversion is illustrated in FIG. 6. The invention further provides that a non-literary symbol may be shown for each letter that comprises the word that does not meet or exceed the predefined accuracy confidence threshold. For example, if the non-displayed word includes five letters, the transcription results would display five consecutive non-literary symbols (to indicate the number of letters that are included in the non-displayed word).

As explained above, since the audio-to-text conversions may be viewed in the centralized website 8 (whether in text boxes associated with search terms or within other areas thereof), the website 8 may further include a set of controls and, particularly, a control that allows a user to quickly and easily adjust the predefined accuracy confidence threshold that is applied to a transcription (either before or after a transcription). For example, the invention provides that the website 8 may include a sliding control, which allows a user to adjust the predefined accuracy confidence threshold up and down, while simultaneously viewing the effect that such adjustment has on the number of words transcribed and the accuracy thereof.

According to yet further preferred embodiments, the systems and methods of the present invention may be used for searching and accessing excerpted portions of media files, such as audio tracks and other voice recordings (including, but not limited to, talk radio files), among a plurality of media files provided by a variety of sources. The invention provides that the media files, e.g., voice recordings, may be provided to the server 2 on a regularly scheduled basis. For example, in the case of talk radio content, the server 2 may be automatically provided with published talk radio content, including audio tracks that may comprise analog or digital content, by a plurality of radio stations. In certain alternative embodiments, the server 2 may employ or be in communication with a recording device (e.g., smart phones, conference phones, and other devices that are capable of recording and/or transferring media files to the server 2), which records and transmits media files to the server 2 (immediately following the production of such media files). The media files, e.g., voice recordings, may then be indexed and categorized within the database 4 as described above, i.e., based on source (e.g., a person, company, radio station, etc.), time of recordation, geographical location of origin, language, key word usage, combinations of the foregoing, and other factors.

The invention provides that the server 2 may receive and manage these media files in many ways, such that the audio tracks (audio content) thereof may be deciphered and used as described herein. For example, as described above, the invention provides that upon a media file being submitted to the server 2, the server 2 may perform a speech-to-text, speech-to-phoneme, speech-to-syllable, and/or speech-to-subword conversion, and then store an output of such conversion within the database 4. This way, as described above, the content of each media file may then be intelligently queried and used in the manner described herein, such as for querying such content for key words.

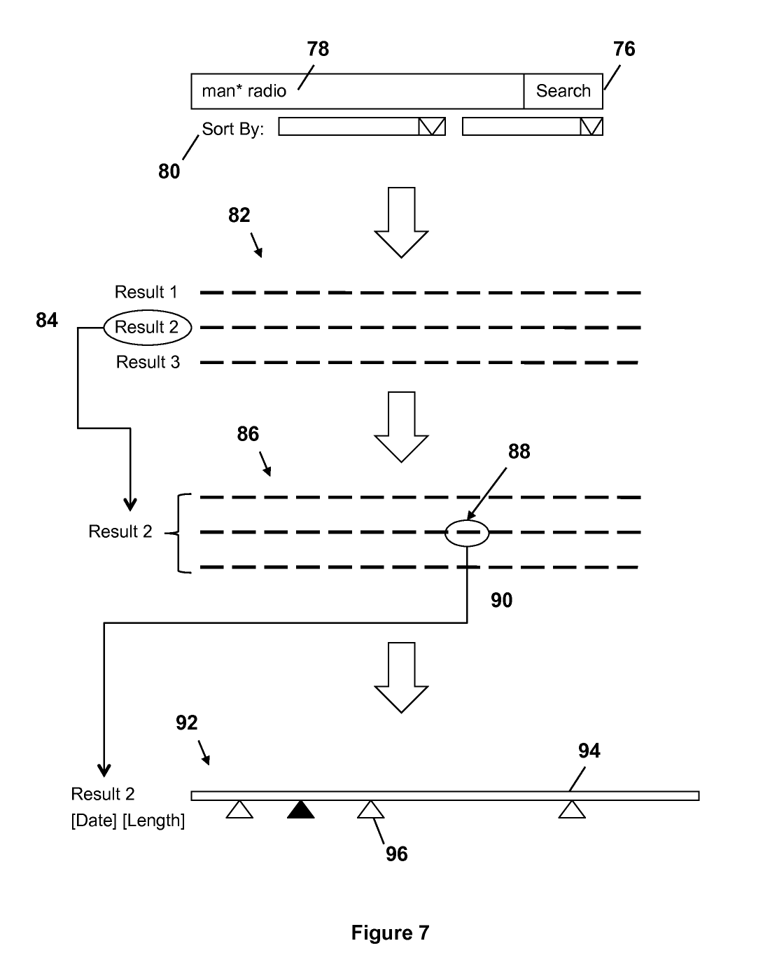

A non-limiting example of a portion of a graphical user interface showing an exemplary search function 76 is provided in FIG. 7. More particularly, the invention provides that the server 2 of the system may be configured to receive one or more key words 78 that are submitted by a user of the system through the website 8, whereupon the server 2 queries the database 4 to identify all media files which include the one or more key words 78. As explained above, the invention provides that the system, and search function 76, may employ Boolean search logic, e.g., by allowing conjunctive and disjunctive searches, truncated and non-truncated forms of key words, exact match searches, and other forms of Boolean search logic.

According to such embodiments, upon receiving a key word that is submitted by a user of the system through the website 8 to identify all media files that include the key word, the server 2 ranks a set of media files included within a set of search results in a defined order. The defined order may rank the media files in chronological order based on a date of recordation in the database 4 for each media file; the defined order may rank the media files based on a number of occasions that the key word is used in each media file; or the ranking may consist of a combination of the foregoing. Alternatively, the order of the media files may be random. The website 8 will preferably include a control that allows a user to cause the server 2 to automatically stream audio tracks (audio content) corresponding to a first media file included within the search results to a device. The invention provides that, at the command of the user, the control may be used to stream audio tracks (audio content) corresponding to a second media file to the device, and so on.

The audio track (audio content) that is streamed to the device will preferably begin at the location of the key word within the media file (or at a position located a pre-defined period of time prior to the first usage of the key word in the media file). The control may then be used to switch from one media file to another (e.g., down the list of search results), until a desirable media file is identified.

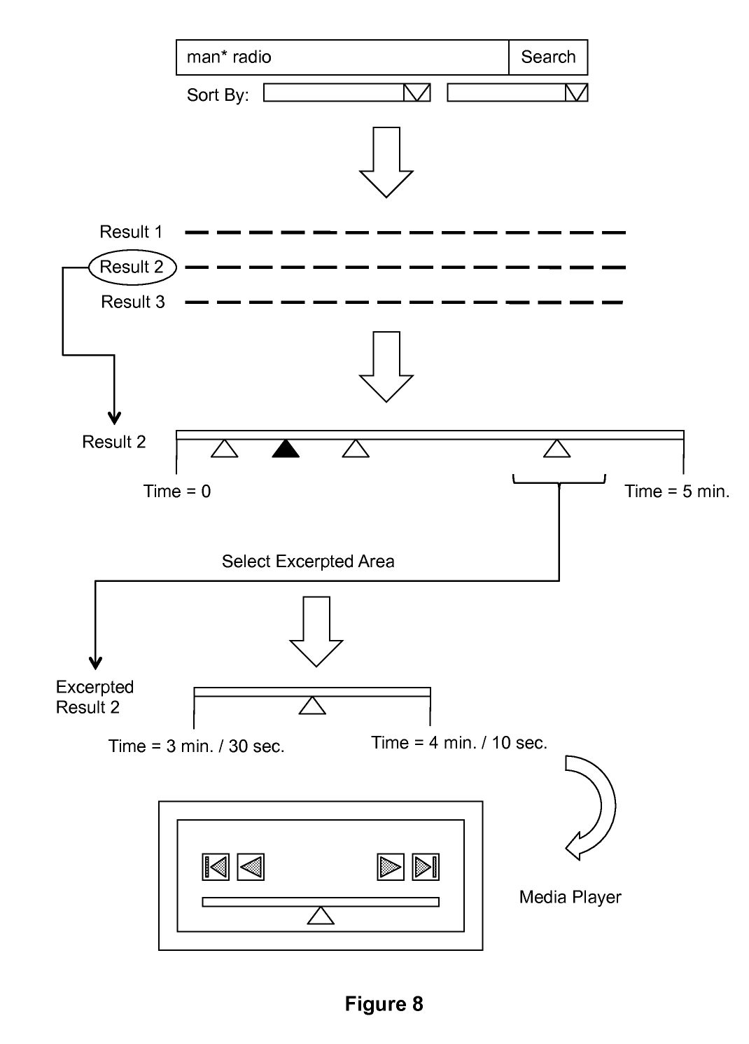

In such embodiments, the search results 82 will preferably consist of a list of media files that include the one or more key words. The server 2 will further provide a means for selecting 84 a media file within the search results, whereupon selecting a media file causes the server 2 to stream an audio track (audio content) to a device 12,14. The invention provides that the audio content will represent an excerpted portion of the media file that begins at (or at a predefined period of time prior to) a location of the queried key word in the audio track (audio content). In other words, referring to FIGS. 7 and 8, if a user selects a specific media file (e.g., a talk radio file) within a set of media files 82 that comprise a set of search results, the server 2 will cause a portion of the corresponding audio content to be streamed to the user's device 12,14. The audio content may begin at the exact location at which a key word is found within the audio content for the selected media file or, alternatively, at a predefined period of time prior to the location of the key word. In certain embodiments, for example, the predefined period of time, e.g., 5, 10, 15, 20, or more seconds, may be specified and adjusted by a user within the centralized website 8.

According to still further embodiments, the present invention provides that upon selecting 84 a media file within the search results 82, the server will publish a portion of the transcribed text 86 that surrounds the location of a key word 88. According to such embodiments, upon selecting 90 the key word 88 (or any other word included in the published text 86), the server 2 will cause a portion of the corresponding audio track (audio content) to be streamed to the user's device 12,14. Here again, the audio content may begin at the exact location at which the selected key word 88 is found within the media file or, alternatively, at a predefined period of time prior to the location of the key word 88.

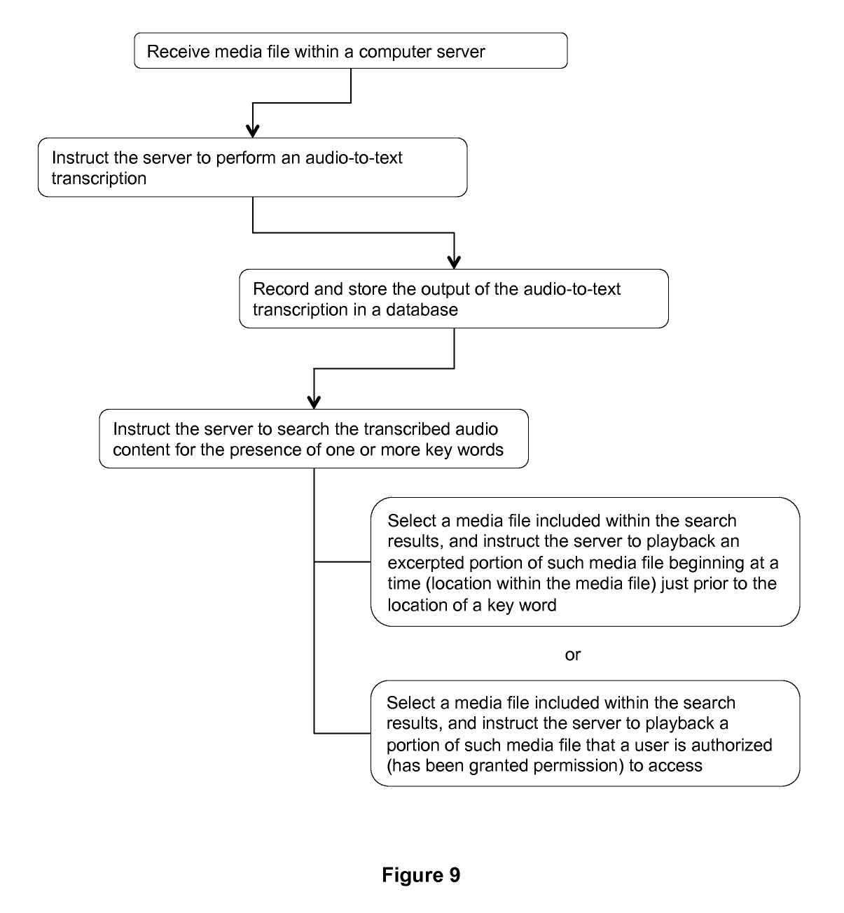

Still referring to FIG. 7, and as described above relative to other embodiments, each media file that is selected and streamed to a user's device 12,14 may be graphically portrayed 92 within the graphical user interface of the centralized website 8. For example, the entire media file (or an excerpted portion thereof) may be portrayed in the form of a line 94 that begins at time equals zero (t=0) and ends at a point when the media file is terminated (or begins at a predefined period of time prior to the first use of a key word and ends at a predefined period of time following the last use of a key word). Still further, in certain preferred embodiments, the invention provides that the location of each key word that was queried may be indicated along the line 94. For example, the location of each search term may be indicated with a triangle 96, or other suitable and readily visible element. The invention further provides that if multiple key word (search) terms were used in the search, the line 94 may be annotated with multiple triangles 96 (or other suitable elements), each of which may exhibit a different color that is correlated with a particular key word (search term). More particularly, for example, if two search terms are used, the line 94 may be annotated with triangles 96 (or other suitable elements), which exhibit one of two colors, with one color representing a location of a first search term and a second color indicating the location of a second search term. Still further, referring to FIG. 8, the invention provides that an entire media file, from beginning to end, may be graphically portrayed (as described above), as well as a selected excerpted portion thereof—and optionally played back and visualized within a media player. The steps of searching for and identifying relevant media files, and then playing (listening to) excerpted portions of such media files, are also summarized in FIG. 9.

The invention provides that the system described herein may further allow users to identify other users who, based on the frequency of certain key word usage, may be experts or knowledgeable regarding a particular topic. For example, the database 4 may be queried for other users who have submitted one or more media files which include the word “golf,” with the search results being listed in the website 8—e.g., the names (or usernames) of such users who satisfy the search criteria. The invention provides that this search functionality will be useful for identifying persons who may be knowledgeable about a particular topic. The search results may be listed in an order that is most relevant to the user, such as by ranking the users who use the search term most often—either relatively or absolutely—and/or based on geographical proximity to the user who initiated the search.

According to certain embodiments, the system may further communicate with one or more social networking sites, such as LinkedIn, MySpace, Facebook, and others. Referring to the example above, when a user submits a key word search as described above, the system will not only list the users (usernames) who have submitted at least one media file which includes the word “golf,” it may also query the communications (i.e., media files stored within the server 2 and database 4) of those users' “friends” and/or “friends-of-friends,” as listed in the associated social networking sites, who have also submitted media files to the server 2 and database 4. This way, a user may quickly identify a group of people who may be knowledgeable about a particular topic. Still further, if the key word is a person's name (or social network username), such functionality would allow users of the system to easily identify other users who may know, or be related to, the person identified by the key word search.

According to further embodiments of the present invention, the media files provided to the server 2 and database 4 by each user may be automatically queried for certain key words included therein. More particularly, the system may query each media file to determine whether any words included therein are found in a pre-recorded list of advertising terms. If such analysis reveals that any of the words included within the media files match any of the pre-recorded advertising terms, the server 2 may cause a relevant advertisement to be posted within the graphical user interface of the website 8 when the user accesses the website 8. Referring to the example above, if a user uploads a media file to the database 4 which includes (in the transcript of the audio content thereof) the word “golf,” the server 2 may published one or more golf-related advertisements in the graphical user interface of the website 8. According to such embodiments, the invention provides that the server 2 will be in communication with one or more databases that correlate certain terms with one or more advertisements.

In addition, the invention provides that whether certain advertisements are posted within the website 8 may be determined not only on whether a particular user's media file includes a certain key word, but also (1) the number of times that such key word is used within a media file, (2) the number of distinct media files provided by the same user over a period of time that includes the key word, or (3) combinations of the foregoing. For example, if the system detects that a particular user has submitted a certain minimum number of media files to the database 4 which include the word “golf” (and not just a single media file that contains such term), the server 2 may cause one or more advertisements related to golf products or golf services to be published in the website 8—when the user visits the website 8 (with the publication of the advertisement being triggered based on the user's IP address) and/or when the user submits a valid username/password to login to the website 8. In addition, the invention provides that other criteria may be employed to determine which advertisement(s) to display, such as the location in which the media file is recorded (e.g., the geographic location may be communicated to the server 2 if a mobile device is used to capture the audio recording), the level of background noise, the quality of the media file, the type of recording device used, and/or other information and data that may be retrieved by the server 2 regarding a user, a media file or the contents thereof.

Still further, the invention provides that advertisements may be posted within the graphical user interface of the website 8 based on the key words that may be used by a particular user to query the database 4 for relevant media files. For example, using the example described above, if a user queries the database 4 for media files that include the word “golf,” the server 2 may search for and determine if the word “golf” matches any terms included within a pre-recorded list of advertising terms and, if so, the server 2 will cause one or more advertisements related to golf products or golf services to be published in the website 8.

According to additional and related embodiments of the present invention, similar to the embodiments described above, systems for recording and sharing media files are provided, which incentivize users of the system to share and publish comments regarding the media files described herein. In other words, such embodiments are designed to encourage users to distribute, and make publicly available, the media files recorded by each user and, in the case of referrals, the media files recorded by other users. According to such embodiments, the server 2 may also be configured to track the number of media files shared by each user of the system. The invention provides that a media file is considered “shared” when a user makes a media file accessible to, or otherwise refers the media file to, another user of the system.

For example, the invention provides that the system may be configured to enable a user to send (such as via e-mail) to another user, directly or indirectly, a hyperlink to the website 8 or a location therein where a particular media file may be accessed—such that the receiving user may listen to and optionally submit comments regarding the media file. In other embodiments, the referring or sharing user may provide instructions to the server 2 that are housed within the database 4, which provide that certain media files submitted to the server 2 by the referring or sharing user may only be accessed by another user (or set of users) specified by the sharing or referring user. Such lists of authorized users, who may access a particular media file, may also be configured and communicated to such authorized users as an invitation to access, listen to, and submit comments regarding a particular media file. As described above, the system may be configured to track the number of media files shared in such manner by each user of the system.

Still further, according to such embodiments, the invention provides that the server 2 may, optionally, be configured to grant credit to each user of the system based on the number of media files shared or referred by each user during a defined period of time. According to such embodiments, the credit that is granted to each user may be redeemed for a variety of items, such as money, gift certificates, gift cards, the right to use the system without charge for a defined period of time, or other items. The invention provides that such credit system will preferably encourage media file sharing among users of the system. The invention provides that the website 8 may include an account page for each user, which lists the amount of accumulated credit that has been awarded to each user at any given time (and, optionally, may further display credit that has been redeemed by the user of the system).

According to still further embodiments of the present invention, methods for recording, indexing, storing, transcribing, sharing, and publishing comments regarding media files are provided, which generally comprise the use of the systems described herein.

The many aspects and benefits of the invention are apparent from the detailed description, and thus, it is intended for the following claims to cover all such aspects and benefits of the invention which fall within the scope and spirit of the invention. In addition, because numerous modifications and variations will be obvious and readily occur to those skilled in the art, the claims should not be construed to limit the invention to the exact construction and operation illustrated and described herein. Accordingly, all suitable modifications and equivalents should be understood to fall within the scope of the invention as claimed herein.

What is claimed is:

1. A system for searching and accessing excerpted portions of media files, which comprises a server that is configured to:
(a) receive, index, and store a plurality of media files, which are received by the server from a plurality of sources, within at least one database in communication with the server;
(b) perform a text transcription of audio content included within the media files;
(c) make one or more of the media files accessible to persons other than the sources of such media files;
(d) displaying a set of results of said transcription within a graphical user interface of a computing device for each word that (i) was converted into text from said audio content and (ii) meets or exceeds a predefined accuracy confidence threshold; and
(e) displaying a non-literary symbol for each word that was converted into text from said audio content, but which does not meet or exceed the predefined accuracy confidence threshold.

2. The system of claim 1, wherein the graphical user interface is provided within a website that is hosted within, or in communication with, the server, and wherein the website allows a user to select the predefined accuracy confidence threshold.

3. The system of claim 2, wherein the transcription is performed using one or more algorithms that are capable of performing a speech-to-text, speech-to-phoneme, speech-to-syllable, or speech-to-subword conversion.

4. The system of claim 3, wherein the server is further configured to:
(a) receive a key word that is submitted by the user of the system through the website, whereupon the server queries the database to identify all media files which include the key word; and
(b) list all media files that include the key word in a defined order within the graphical user interface of the website.

5. The system of claim 4, wherein the defined order is selected from a list that comprises: (a) listing the media files in chronological order based on a date of recording in the database for each media file, (b) listing the media files based on a number of occasions that the key word is used in each media file, (c) listing the media files based on a density of key word usage within a defined portion of each media file, d) listing by occurrence of key words in metadata associated with the media files, e) listing by measuring user activity associated with media files containing key words, and f) combinations of the foregoing.

6. The system of claim 5, wherein the website comprises a graphical user interface that portrays a beginning and an end of each media file, and a location of each key word contained therein.

7. The system of claim 6, wherein the website is configured to display a text box in which a key word and surrounding transcribed context is shown upon placing a cursor over an element that indicates the location of a key word contained in the media file.

8. The system of claim 7, wherein the server is configured to receive and publish comments associated with the media files within the graphical user interface of the website, wherein the comments are submitted to the server through the website by the persons other than the sources of such media files.

9. A system for searching and accessing excerpted portions of media files, which comprises a server that is configured to:
(a) receive, index, and store a plurality of media files, which are received by the server from a plurality of sources, within at least one database in communication with the server;
(b) perform a text transcription of audio content included within the media files;
(c) allow a user of the system to search the plurality of media files for the presence of one or more key words through a centralized website; and
(d) stream audio content to a device, wherein the streamed audio content represents an excerpted portion of a media file, or a portion of a media file that the user is authorized to access, which begins at a predefined period of time prior to a location of the one or more key words in the audio content.

10. The system of claim 9, wherein upon receiving a key word that is submitted by a user of the system through the website to identify all media files which include the key word, the server ranks a set of media files included within a set of search results in a defined order.

11. The system of claim 10, wherein the defined order is selected from a list that comprises: (a) listing the media files in chronological order based on a date of recording in the database for each media file, (b) listing the media files based on a number of occasions that the key word is used in each media file, (c) listing the media files based on a density of key word usage within a defined portion of each media file, d) listing by occurrence of key words in metadata associated with the media files, e) listing by measuring user activity associated with media files containing key words, and f) combinations of the foregoing.

12. The system of claim 11, wherein the website includes a control that allows a user to cause the server to (a) stream audio content corresponding to a first media file included within the search results to the device; and (b) at the command of the user, stream audio content corresponding to a second media file to the device.

13. The system of claim 12, wherein the website comprises a graphical user interface that portrays a beginning and an end of each media file, and a location of each key word contained therein.

14. The system of claim 13, wherein the website is configured to display a text box in which a key word and surrounding transcribed context is shown upon placing a cursor over an element that indicates the location of a key word contained in the media file.

15. The system of claim 14, wherein the server is configured to receive and publish comments associated with the media files within the graphical user interface of the website, wherein the comments are submitted to the server through the website by the persons other than the sources of such media files.
